(19) United States
(12) Patent Application Publication
(10) Pub. No.: US 2026/0128872 A1
(43) Pub. Date: May 7, 2026

(54) System and method for encrypting and securing stored sensitive data based on the quantum echo effect

(71) Applicant: Bank of America Corporation, Charlotte, NC (US)

(72) Inventors: Adam K. King, Fort Mill, SC (US); James Siekman, Charlotte, NC (US); Sanjay Lohar, Mint Hill, NC (US); Matthew K. Bryant, Mt. Holly, NC (US); Catherine Cunningham, Charlotte, NC (US); Takiyah Watford, Fort Mill, SC (US); Elizabeth Swanzy-Parker, Charlotte, NC (US); Peter Nein, Waxhaw, NC (US)

(21) Appl. No.: 18/923,885

(22) Filed: Oct. 23, 2024

(51) Int. Cl. H04L 9/08; G06F 21/60; G06N 10/40

(52) U.S. Cl. CPC H04L 9/0858; G06F 21/602; G06N 10/40

(57) ABSTRACT

A system includes a quantum memory configured to store sensitive data to be transmitted to a quantum computing device over an optical communication channel and a quantum processor operably coupled to the quantum memory and configured to generate pairs of entangled quantum bits (QuBits), and further encode each pair of the pairs of entangled QuBits based on the sensitive data. The pairs of entangled QuBits include the sensitive data. The quantum processor is further configured to store the pairs of entangled QuBits to a predetermined quantum storage medium configured to maintain a state of each pair of the pairs of entangled QuBits, identify, based on a change in state associated with one Qubit of a pair of the pairs of entangled QuBits, an unauthorized measurement of the pairs of entangled QuBits, and in response to identifying the unauthorized measurement, cause the pairs of entangled QuBits to be rendered unreadable.

### TECHNICAL FIELD

The present disclosure relates generally to quantum computing, and, more specifically, to a system and method for encrypting and securing stored sensitive data based on the quantum echo effect.

### BACKGROUND

Existing public-key encryption algorithms, such as Rivest-Shamir-Adleman (RSA) encryption algorithms, face significant challenges in ensuring the security of communication channels against sophisticated cyberattacks and cyberthreats, such as those that may be implemented utilizing quantum computing. Specifically, existing RSA encryption algorithms rely on the assumption that factoring large prime numbers is computationally intensive for classical computing systems, and thus ensure the secure transmission and reception of sensitive data over communication channels. However, because quantum computing systems may be especially suited for “cracking” RSA encryption algorithms rather trivially (e.g., by way of Shor's algorithm), “harvest now, decrypt later” (HNDL) attacks may allow an attacker, an eavesdropper, or other adversarial user to intercept and store encrypted sensitive data until a future time at which quantum computing systems and resources are more feasible and readily available to decrypt the intercepted and harvested encrypted sensitive data. Thus, encrypted sensitive data may be susceptible to “harvest now, decrypt later” (HNDL) attacks during both the transmission and reception of encrypted sensitive data over communication channels, as well as during the storage of the encrypted sensitive data.

### SUMMARY

The system and methods implemented by the system as disclosed in the present disclosure provide technical solutions to the technical problems discussed above by providing systems and methods for encrypting and securing stored sensitive data based on the quantum echo effect. The disclosed system and methods provide several practical applications and technical advantages. Specifically, the present embodiments improve the security and network efficiency of optical communications channels and data storage security by encrypting and securing stored sensitive data based on the quantum echo effect.

Specifically, the present embodiments provide a quantum computing system that may be utilized to encode, encrypt, and securely store sensitive data to be transmitted over an optical communication channel to a predetermined quantum storage medium. For example, in accordance with the presently disclosed embodiments, the quantum computing system may generate one or more pairs of entangled quantum bits (QuBits) and encode each pair of the one or more pairs of entangled QuBits based on the sensitive data, whereupon the encoding, the one or more pairs of entangled QuBits includes the sensitive data.

In particular embodiments, the quantum computing system may then store the one or more pairs of entangled QuBits to a predetermined quantum storage medium that may be utilized to maintain a quantum state of each pair of the one or more pairs of entangled QuBits over an extensive period of time. The quantum computing system may then identify, based on a detected change in a quantum state of at least one Qubit of a pair of the one or more pairs of entangled QuBits, an unauthorized measurement of the one or more pairs of entangled QuBits, and, in response to identifying the unauthorized measurement of the one or more pairs of entangled QuBits, the quantum computing system may cause the one or more pairs of entangled QuBits to be rendered unreadable.

Accordingly, utilizing the quantum computing system and leveraging the principles of quantum entanglement and the quantum echo effect, the present embodiments improve the security and network efficiency of optical communications channels and data storage security by encrypting and securing stored sensitive data based on the quantum echo effect. Specifically, in accordance with the principles of quantum entanglement, QuBits interact with each other and are represented by reference to one another, regardless of whether the QuBits are spatially close together or separated spatially by a large distance. For example, at the time of measurement, if one entangled QuBit in a pair of entangled QuBits is determined to be in a “spin” state of “down,” the quantum computing system may then immediately configure the other entangled QuBit in the pair of entangled QuBits to assume the opposite “spin” state of “up,”for example.

That is, in accordance with the principles of quantum entanglement, QuBits, even those that are spatially far away from each other, interact instantaneously with each other. In this way, if an attacker, an eavesdropper, or other adversarial user interacts with even just one QuBit of a pair of entangled QuBits, the other QuBit of the pair of entangled QuBits will also be instantaneously impacted by the interaction (e.g., regardless of whether the individual QuBits are spatially close together or separated spatially by a large distance). Accordingly, utilizing the quantum computing system and leveraging the principles of quantum entanglement, the present embodiments improve the security and network efficiency of optical communications channels and data storage security by encrypting and securing stored sensitive data based on the quantum echo effect, and thereby ensure secure sensitive data communications between sending quantum computing systems and receiving quantum computing systems and the secure transmission and reception of sensitive data over optical communication channels.

Additionally, in accordance with the principles of the quantum echo effect, due to the one or more pairs of entangled QuBits being stored to a quantum storage medium suitable for maintaining the quantum state of each QuBit of each pair of the one or more pairs of entangled QuBits over an extended period of time—in accordance with the principles of the quantum echo effect—any unauthorized observance (e.g., a measurement) of even one entangled QuBit of each pair of the one or more pairs of entangled QuBits may be identified and detected by the quantum computing system.

That is, in accordance with the principles of the quantum echo effect, any unauthorized observance (e.g., a measurement) of even one entangled QuBit of each pair of the one or more pairs of entangled QuBits may be immediately indicative of a security compromise of the stored encoded sensitive data. For example, in accordance with the presently disclosed embodiments, the quantum computing system may identify the unauthorized observance (e.g., a measurement) of an entangled QuBit by detecting an instantaneous “echo” response generated within the quantum storage medium that may be created in response to the unauthorized observance (e.g., a measurement).

Accordingly, utilizing the quantum computing system and leveraging the principles of the quantum echo effect, the present embodiments improve the security and network efficiency of optical communications channels and data storage security by encrypting and securing stored sensitive data based on the quantum echo effect. The present embodiments may thereby ensure secure short-term and long-term sensitive data storage, and may further obviate the threat of “harvest now, decrypt later” (HNDL) attacks by encrypting and storing encoded sensitive data to a predetermined quantum storage medium in accordance with the quantum echo effect.

The present embodiments are directed to systems and methods for encrypting and securing stored sensitive data based on the quantum echo effect. In particular embodiments, a system includes a quantum memory configured to store sensitive data to be transmitted to a quantum computing device over an optical communication channel. In one embodiment, the optical communication channel may include one or more of an optical fiber link or a free-space optical link. In particular embodiments, the system may further include one or more quantum processors operably coupled to the quantum memory and configured to generate one or more pairs of entangled quantum bits (QuBits). For example, in one embodiment, the one or more quantum processors may be configured to generate the one or more pairs of entangled QuBits by utilizing one or more of a quantum dot (QD), a high-intensity laser, or a quantum particle generator.

In particular embodiments, the one or more pairs of entangled QuBits may include one or more pairs of entangled photons, one or more pairs of entangled electrons, one or more pairs of entangled neuronal impulses, or one or more pairs of entangled subatomic particles. In particular embodiments, the one or more quantum processors may be further configured to encode each pair of the one or more pairs of entangled QuBits based at least in part on the sensitive data, where, upon the encoding, the one or more pairs of entangled QuBits includes the sensitive data. For example, in particular embodiments, the one or more quantum processors may be configured to encode each pair of the one or more pairs of entangled QuBits by utilizing a quantum modulator configured to alter a polarization or a spin of at least one QuBit of each pair of the one or more pairs of entangled QuBits.

In particular embodiments, the one or more quantum processors may be further configured to store the one or more pairs of entangled QuBits to a predetermined quantum storage medium configured to maintain a state of each pair of the one or more pairs of entangled QuBits. For example, in particular embodiments, the quantum storage medium may include one or more of a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, or a controlled reversible inhomogeneous broadening of a single atomic absorption line (CRIB) storage medium.

In particular embodiments, the one or more quantum processors may be further configured to identify, based at least in part on a change in state associated with one Qubit of a pair of the one or more pairs of entangled QuBits, an unauthorized measurement of the one or more pairs of entangled QuBits. For example, in particular embodiments, prior to identifying the unauthorized measurement of the one or more pairs of entangled QuBits, the one or more quantum processors may be configured to transmit, over the optical communication channel, the one or more pairs of entangled QuBits to the quantum computing device and identify, based at least in part on a comparison of a first set of measurements and a second set of measurements the one or more pairs of entangled QuBits, a quantum cryptographic key. In one embodiment, the optical communication channel may be configured to utilize quantum tunneling to channel the one or more pairs of entangled QuBits to the quantum computing device. In one embodiment, the quantum cryptographic key may be configured to be shared between the system and the quantum computing device.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a combined classical computing and quantum computing system and network, in accordance with certain aspects of the present disclosure;

FIG. 2 illustrates a diagram of an encoding and encryption architecture for encrypting and securing stored sensitive data based on the quantum echo effect, in accordance with one or more embodiments of the present disclosure; and

FIG. 3 illustrates a flowchart of an example method for encrypting and securing stored sensitive data based on the quantum echo effect, in accordance with one or more embodiments of the present disclosure.

### DETAILED DESCRIPTION

### Example System

### System Overview

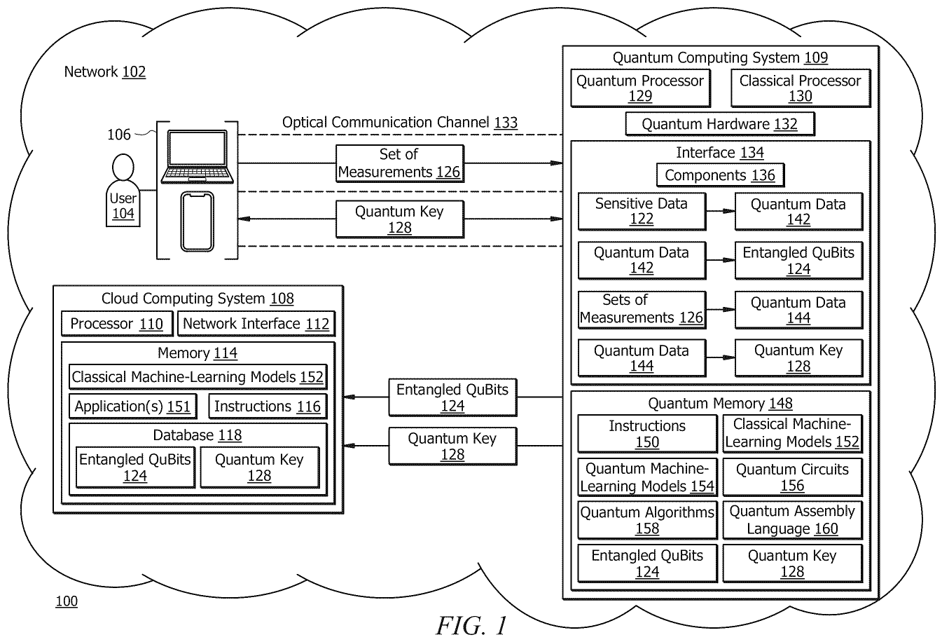

FIG. 1 is a block diagram of a combined classical computing and quantum computing system 100. As depicted, the combined classical computing and quantum computing system 100 may include one or more computing devices 102 that may be associated with a user 104, a cloud computing system 108, a quantum computing system 109, and a network 106 that enables the communications between the one or more computing devices 102, the cloud computing system 108, and the quantum computing system 109. In particular embodiments, the cloud computing system 108 and the quantum computing system 109 may be owned and managed by a single entity or organization, and thus, in some embodiments, the cloud computing system 108 and the quantum computing system 109 may operate in conjunction and/or may be integrated to operate as a singular computing infrastructure. In general, the combined classical computing and quantum computing system 100 may be utilized to encrypt and secure stored sensitive data 122 based on the quantum echo effect.

In another embodiment, one of the cloud computing system 108 and the quantum computing system 109 may be owned and managed by the single entity or organization while the other one of the cloud computing system 108 and the quantum computing system 109 may be owned and managed by a third-party entity or organization and licensed to be utilized by the single entity or organization. In one embodiment, the cloud computing system 108 may include a classical computing system suitable for executing binary or bitwise processing operations. In contrast, the quantum computing system 109 may include a quantum computing system suitable for executing superposed and entangled or quantum bit (QuBit) based parallel processing operations.

### Network

Network 106 may be any suitable type of wireless and/or wired network. The network 106 may or may not be connected to the Internet or public network. The network 106 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, and/or any other suitable network. The network 106 may be configured to support any suitable type of communication protocol as would be appreciated by one of ordinary skill in the art.

### Computing Device

Computing device 102 is generally any device that may be utilized to process data and interact with a user 104. Examples of the computing device 102 include, but are not limited to, a personal computer, a desktop computer, a workstation, a server, a laptop, a tablet computer, a mobile phone (such as a smartphone), etc. The computing device 102 may include a user interface, such as a display, a microphone, keypad, or other appropriate terminal equipment usable by the user 104. The computing device 102 may include a hardware processor, memory, and/or circuitry (not explicitly shown) configured to perform any of the functions or actions of the computing device 102 described herein. For example, a software application designed using software code may be stored in the memory and executed by the processor to perform the functions of the computing device 102. The computing device 102 may be utilized to communicate with other components of the system 100 via the network 106.

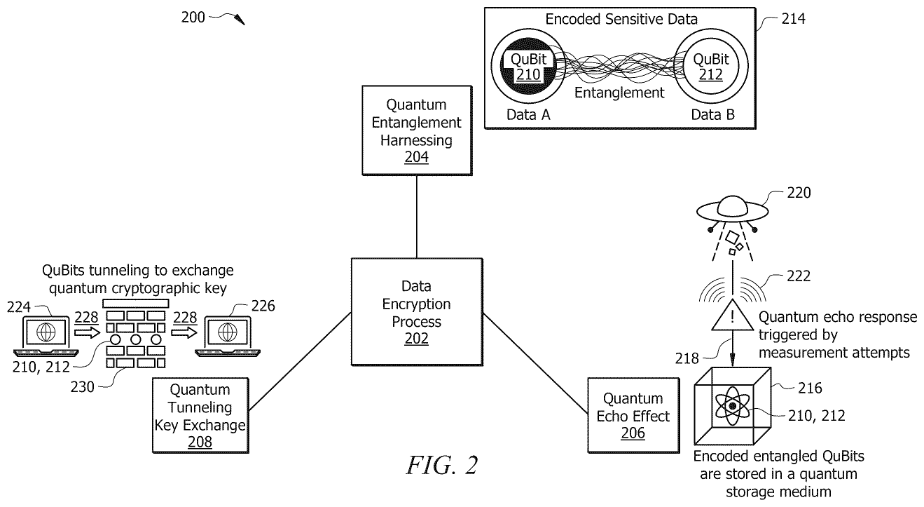

In particular embodiments, the computing device 102 may include a quantum computing device 102 suitable for executing superposed and entangled QuBit based parallel processing operations. For example, in particular embodiments, as will be further discussed below with respect to FIG. 2, the quantum computing device 102 may be utilized by the user 104 to communicate and exchange data over the network 106 or an optical communication channel 133 to the quantum computing system 109 and/or the cloud computing system 108. For example, the quantum computing device 102 may receive, over the optical communication channel 133, one or more pairs of entangled QuBits 124 including a first quantum cryptographic key from the quantum computing system 109 and may provide, over the optical communication channel 133, a set of measurements 126 of the one or more pairs of entangled QuBits 124 to the quantum computing system 109. The quantum computing system 109 may then generate a quantum cryptographic key 128 to be exchanged between the quantum computing system 109 and the quantum computing device 102.

In particular embodiments, the optical communication channel 133 may include one or more of an optical fiber link (e.g., one or more fiber optic cables) or a free-space optical link (e.g., photons of light emitted through free space) that may be established between the quantum computing device 102 and the quantum computing system 109. For example, in particular embodiments, the set of measurements 126 of the one or more pairs of entangled QuBits 124 and the quantum cryptographic key 128 may be transmitted between the quantum computing system 109 and the quantum computing device 102 as one or more rays or streams of photons of light or entangled photons of light.

### Cloud Computing System

The cloud computing system 108 may include any computing that may be utilized to process data and communicate with other components of the system 100 via the network 106. In one embodiment, the cloud computing system 108 may include a classical computing system suitable for executing binary or bitwise processing operations. As depicted, the cloud computing system 108 may include a processor 110 in signal communication with a memory 114 and a network interface 112.

Processor 110 may include one or more processors operably coupled to the memory 114. The processor 110 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 110 may be a programmable logic device, a microcontroller, a microprocessor, or any suitable combination of the preceding. The one or more processors 110 may be utilized to process data and may be implemented in hardware or software.

For example, the processor 110 may be 8-bit, 16-bit, 32-bit, 64-bit, or of any other suitable architecture. The one or more processors 110 may be utilized to implement various software instructions to perform the operations described herein. For example, the one or more processors 110 may be utilized to execute software instructions 116 and perform one or more functions described herein. In one embodiment, the processor 110 may be understood to be a classical processor.

Network interface 112 may be utilized to enable wired and/or wireless communications (e.g., via network 106). The network interface 112 is configured to communicate data between the cloud computing system 108 and other components of the system 100. For example, the network interface 112 may include a WIFI interface, a local area network (LAN) interface, a wide area network (WAN) interface, a modem, a switch, or a router. The processor 110 may be utilized to send and receive data using the network interface 112. The network interface 112 may be utilized to use any suitable type of communication protocol as would be appreciated by one of ordinary skill in the art.

Memory 114 may be volatile or non-volatile and may include a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1-3 along with any other data, instructions, logic, rules, or code operable to implement the function(s) described herein. The memory 114 is operable to store software instructions 116, and/or any other data and instructions.

The software instructions 116 may include any suitable set of software instructions, logic, rules, or code operable to be executed by the processor 110. In particular embodiments, the memory 114 may further store a database 118, which may include a structured data base (e.g., structured query language (SQL) database, a non-SQL database, or other similar relational database), an unstructured database, a sorted data structure, or an unsorted data structure. In one embodiment, the memory 114 may be understood to be a classical memory. In one embodiment, the memory 114 may include a non-transitory computer-readable medium. In one embodiment, the database 118 may be utilized to store the one or more pairs of entangled QuBits 124 and the quantum cryptographic key 128 as one or more classical binary bits of data.

### Quantum Computing System

The quantum computing system 109 may include any quantum computing system that may be utilized to process data and communicate with other components of the system 100 via the network 106 and/or the optical communication channel 133. In one embodiment, the quantum computing system 109 may include a quantum computing system suitable for executing superposed and entangled or quantum bit (QuBit) based parallel processing operations. As depicted, the quantum computing system 109 may include a quantum processor 129, a classical processor 130, and an interface 134 in signal communication with a quantum memory 148.

The quantum processor 129 may include one or more quantum processors operably coupled to the quantum memory 148. The quantum processor 129 is configured to process quantum bits (QuBits). The quantum processor 129 may include a superconducting quantum device (with QuBits implemented by states of Josephson junctions), a trapped ion device (with qubits implemented by internal states of trapped ions), a trapped neutral atom device (with QuBits implemented by internal states of trapped neutral atoms), a photon-based device (with QuBits implemented by modes of photons), or any other suitable device that implements quantum bits with states of a respective quantum system.

In particular embodiments, the quantum processor 129 may be a quantum processing unit (QPU), which may include a number of quantum registers, a dedicated quantum memory, and a number of quantum logic gates (e.g., a quantum logic gate, a Hadamard logic gate, a Pauli-X logic gate, a Pauli-Y logic gate, a Pauli-Z logic gate, a controlled NOT logic gate, and so forth) suitable for executing superposed and entangled or quantum bit (QuBit) based parallel processing operations.

In particular embodiments, the quantum processor 129 may be further utilized to perform quantum computations, such as quantum annealing, quantum simulations, and universal quantum computing. For example, in particular embodiments, the quantum processor 129 may, in conjunction with the quantum memory 148 and utilizing the quantum hardware 132, execute one or more classical machine-learning (CML) models 152, one or more quantum machine-learning (QML) models 154, one or more quantum circuits 156, one or more quantum algorithms 158, and/or one or more quantum assembly languages 160 for performing operations on the one or more pairs of entangled QuBits 124, a first set of measurements of the one or more pairs of entangled QuBits 124, the set of measurements 126 of the one or more pairs of entangled QuBits 124, the quantum cryptographic key 128.

In particular embodiments, the one or more classical machine-learning (CML) models 152 may include, for example, one or more of a spiking neural network (SNN), an autoencoder (AE), a variational autoencoder (VAE), a generative adversarial network (GAN), a convolutional neural network (CNN), a deep neural network (DNN), a deep convolutional neural network (DCNN), a graph neural network (GNN), a graph convolutional network (GCN), a bidirectional and auto-regressive transformer (BART) model, a bidirectional encoder representations for transformer (BERT) model, a generative pre-trained transformer (GPT) model, a graph transformer, or other similar machine-learning model. In another embodiment, the one or more classical machine-learning (CML) models 152 may include one or more language models (LMs) or large language model (LLMs).

Similarly, in particular embodiments, the one or more quantum machine-learning (QML) models 154 may include one or more of a quantum-enhanced machine-learning model, a quantum-inspired machine-learning model, a quantum-generalized machine-learning model, or any of various other machine-learning models in which the processing power of quantum computing and the properties of quantum physics are utilized to accelerate machine-learning tasks. Specifically, it should be appreciated that the quantum computing system 109 may be capable of executing both the one or more classical machine-learning (CML) models 152 and the one or more quantum machine-learning (QML) models 154 in accordance with the presently disclosed embodiments. On the other hand, the cloud computing system 108 may be capable of executing only the one or more classical machine-learning (CML) models 152.

In particular embodiments, the quantum hardware 132 may include, for example, a number of quantum bits (QuBits), a number of QuBit connectors, a number of QuBit interconnector circuits for control operations, and a quantum random access memory (QRAM). The one or more quantum circuits 156 may include a sequence of quantum logic gates suitable for representing and expressing each step of the one or more one or more quantum algorithms 158. For example, the one or more quantum algorithms 158 may include any of various quantum algorithms, such as quantum annealing algorithms, quantum simulation algorithms, quantum search algorithms (e.g., Grover's algorithm), quantum cryptography algorithms (e.g., Shor's algorithm, Deutsch-Jozsa Algorithm, Harrow-Hassidim-Lloyd (HHL) algorithm, Quantum Monte Carlo algorithm, and so forth), one or more quantum Fourier transform (QFT) based algorithms or inverse quantum Fourier transform (iQFT) based algorithms, one or more classical quantum hybrid algorithms (e.g., Quantum Eigensolver), one or more classical quantum variational algorithms, one or more post-quantum cryptographic algorithms (e.g., quantum-resistant encryption algorithms), and/or other user-developed quantum algorithms that may be represented by instructions 150.

The classical processor 130 may include one or more processors operably coupled to the quantum memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein.

The interface 134 may be utilized to convert data items represented by classical binary bits of data into to quantum bits (QuBits) of data. For example, in some embodiments, the interface 134 may convert the sensitive data 122 data represented as classical binary bits of data into quantum data 142 for further processing, and, similarly, convert sets of measurements 126 represented as classical binary bits of data into quantum data 144 for further processing, for example. In particular embodiments, the quantum data 142 and the quantum data 144 may represent one or more pairs of entangled QuBits 124.

In particular embodiments, the interface 134 may be further utilized to convert data items represented by quantum bits (QuBits) of data into classical binary bits of data. For example, in particular embodiments, upon the quantum computing system 109 encoding the sensitive data 122 based on the quantum data 142, the interface 134 may convert the quantum data 142 representing the one or more pairs of entangled QuBits 124 into classical binary bits of data representing the one or more pairs of entangled QuBits 124. Likewise, upon the quantum computing system 109 generating or receiving the set of measurements 126 based on the quantum data 144, the interface 134 may convert the quantum data 144 representing the quantum cryptographic key 128 into classical binary bits of data representing the quantum cryptographic key 128.

In particular embodiments, the interface 134 may include a number of components 136 that may be utilized to generate and manipulate the one or more pairs of entangled QuBits 124. In the illustrated embodiment, the number of components 136 and the quantum processor 129 are configured to operate on a same type of QuBits. For example, when the quantum processor 129 includes a photon-based device (with QuBits implemented by modes of photons), the number of components 136 may include optical components such as lasers, mirrors, prisms, waveguides, interferometers, optical fibers, filters, polarizers, and/or lenses.

In particular embodiments, the number of components 136 may further include one or more quantum-based light sources, such as one or more semiconductor quantum dots (QDs), a high-intensity laser, a quantum particle generator, or other similar quantum-based light source that may be utilized to generate the one or more pairs of entangled QuBits 124. In accordance with the presently disclosed embodiments, the number of components 136 may further include a quantum modulator that may be utilized to alter a polarization or a “spin” of one or more QuBits of each pair of the one or more pairs of entangled QuBits 124.

For example, in accordance with presently disclosed embodiments, the quantum computing system 109 may utilize the number of components 136 to generate one or more pairs of entangled quantum bits QuBits 124 and further encode each pair of the one or more pairs of entangled QuBits 124 based at least in part on the sensitive data 122. Upon the encoding of each pair of the one or more pairs of entangled QuBits 124, the one or more pairs of entangled QuBits 124 may include the sensitive data 122. The quantum computing system 109 may then store the one or more pairs of entangled QuBits 124 to a predetermined quantum storage medium (e.g., quantum memory 148) that may be utilized to maintain a quantum state of each pair of the one or more pairs of entangled QuBits 124.

In particular embodiments, the quantum computing system 109 may identify, based on a detected change in a quantum state of at least one Qubit of a pair of the one or more pairs of entangled QuBits 124, an unauthorized measurement of the one or more pairs of entangled QuBits 124. In response to identifying the unauthorized measurement of the one or more pairs of entangled QuBits 124, the quantum computing system 109 may cause the one or more pairs of entangled QuBits 124 to be rendered unreadable.

Quantum memory 148 may include a quantum read-only memory (QROM), quantum random-access memory (QRAM), or other similar quantum memory. The quantum memory 148 may store any of the information described in FIGS. 1 and 2 along with any other data, instructions, logic, rules, or code operable to implement the function(s) described herein. The quantum memory 148 is operable to store software instructions 150, and/or any other data and instructions. The software instructions 150 may include any suitable set of software instructions, logic, rules, or code operable to be executed by the quantum processor 129. In one embodiment, the quantum memory 148 may include a non-transitory computer-readable medium.

In another embodiment, the quantum memory 148 may include a quantum storage medium 216, which may be utilized to store the one or more pairs of entangled QuBits once generated by the one or more quantum light sources (e.g., semiconductor QDs, high-intensity laser, quantum particle generator). For example, in one embodiment, the quantum memory 148 may include, for example, a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, a controlled reversible inhomogeneous broadening of a single atomic absorption line (CRIB) storage medium, or other similar quantum storage medium.

### Encrypting and Securing Stored Sensitive Data Based on the Quantum Echo Effect

Embodiments of the present disclosure discuss techniques for encrypting and securing stored sensitive data based on the quantum echo effect.

FIG. 2 illustrates a diagram of an encoding and encryption architecture 200 for encrypting and securing stored sensitive data based on the quantum echo effect, in accordance with certain aspects of the present disclosure. In one embodiment, the encoding and encryption architecture 200 may be a further illustrative example of the combined classical computing and quantum computing system 100 as described above with respect to FIG. 1. As depicted, the encoding and encryption architecture 200 may include data encryption compute component 202, a quantum entanglement compute component 204, a quantum echo effect compute component 206, and a quantum tunneling compute component 208. In particular embodiments, the data encryption compute component 202, the quantum entanglement compute component 204, the quantum echo effect compute component 206, and the quantum tunneling compute component 208 may each include a compute, a processing workload, and/or one or more processing tasks that may be executed, for example, as part of the quantum processor 129 as described above with respect to FIG. 1.

In particular embodiments, the quantum entanglement compute component 204 may be utilized to generate one or more pairs of entangled QuBits 210, 212, and further utilize the generated one or more pairs of entangled QuBits 210, 212 to encode each pair of the one or more pairs of entangled QuBits in accordance with sensitive data to be transmitted, for example, to a receiving quantum computing device, such as quantum computing device 102. For example, in particular embodiments, the quantum entanglement compute component 204 may generate the one or more pairs of entangled QuBits 210, 212 and encode the one or more pairs of entangled QuBits to generate encoded sensitive data 214. In one embodiment, the quantum entanglement compute component 204 may generate the one or more pairs of entangled QuBits 210, 212 by utilizing one or more of a quantum dot (QD), a high-intensity laser, or a quantum particle generator that may be included as part of the quantum computing system 109, for example.

Specifically, in accordance with the presently disclosed embodiments, the quantum entanglement compute component 204 may generate and encode the one or more pairs of entangled QuBits 210, 212 in such a manner, for example, that a quantum state of each QuBit 210, 210 of each pair of the one or more pairs of entangled QuBits 210, 212 may be inextricably associated with the underlying sensitive data being encoded as encoded sensitive data 214. For example, in particular embodiments, the quantum entanglement compute component 204 may encode each pair of the one or more pairs of entangled QuBits 210, 212 by utilizing a quantum modulator utilized to alter a polarization or a “spin” of at least one QuBit 210, 212 of each pair of the one or more pairs of entangled QuBits 210, 212.

As further depicted, in particular embodiments, the quantum echo effect compute component 206 may be utilized to store the one or more pairs of entangled QuBits 210, 212 to a predetermined quantum storage medium 216. In particular embodiments, the quantum storage medium 216 may include any quantum storage medium 216 suitable for maintaining the quantum state of each QuBit 210, 210 of each pair of the one or more pairs of entangled QuBits 210, 212. For example, in one embodiment, the quantum storage medium 216 may include, for example, a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, a controlled reversible inhomogeneous broadening of a single atomic absorption line (CRIB) storage medium, or other similar quantum storage medium that may be suitable for maintaining the quantum state of each QuBit 210, 210 of each pair of the one or more pairs of entangled QuBits 210, 212 over an extended period of time (e.g., days, months, years, and so forth).

In particular embodiments, due to the one or more pairs of entangled QuBits 210, 212 being generated and stored to the quantum storage medium 216 in accordance with the principles of quantum entanglement, the one or more pairs of entangled QuBits 210, 212 may interact with each other and may be further represented by reference to one another (e.g., regardless of whether the individual QuBits 210, 212 are spatially close together or separated spatially by a large distance). Furthermore, in accordance with the presently disclosed embodiments, due to the one or more pairs of entangled QuBits 210, 212 being stored to such a quantum storage medium 216 suitable for maintaining the quantum state of each QuBit 210, 212 of each pair of the one or more pairs of entangled QuBits 210, 212 over an extended period of time—in accordance with the principles of the quantum echo effect—any unauthorized observance 218 (e.g., a measurement) of even one entangled QuBit 210, 212 of each pair of the one or more pairs of entangled QuBits 210, 212 may be identified and detected by the quantum echo effect compute component 206.

That is, in accordance with the principles of the quantum echo effect, any unauthorized observance 218 (e.g., a measurement) of even one entangled QuBit 210, 212 of each pair of the one or more pairs of entangled QuBits 210, 212 by, for example, an adversarial user 220 (e.g., an attacker, an eavesdropper, and so forth) may be immediately indicative of a security compromise of the underlying encoded sensitive data 214. For example, in accordance with the presently disclosed embodiments, the quantum echo effect compute component 206 may identify the unauthorized observance 218 (e.g., a measurement) of an entangled QuBit 210, 212 by detecting an instantaneous “echo” response 222 generated within the quantum storage medium 216 that may be created in response to the unauthorized observance 218 (e.g., a measurement).

In particular embodiments, upon the quantum echo effect compute component 206 identifying the unauthorized observance 218 (e.g., a measurement), the quantum echo effect compute component 206 may then cause the one or more pairs of entangled QuBits 210, 212 to be rendered unreadable. For example, in one embodiment, the “echo” response 222 generated within the quantum storage medium 216 and detected by the quantum echo effect compute component 206 may include any environmental noise that may reverberate through the quantum storage medium 216 in response to the unauthorized observance 218 (e.g., a measurement).

Specifically, the “echo” response 222 may distort or collapse a quantum state of one or more QuBits 210, 210 of each pair of the one or more pairs of entangled QuBits 210, 212, and thus render the underlying encoded sensitive data 214 unreadable. In this way, the quantum echo effect compute component 206 may ensure secure short-term and long-term sensitive data storage, and may further obviate the threat of “harvest now, decrypt later” (HNDL) attacks by encrypting and storing the encoded sensitive data 214 to the quantum storage medium 216 in accordance with the quantum echo effect.

In particular embodiments, the quantum tunneling compute component 208 may be utilized transmit, over an optical communication channel 228, the one or more pairs of entangled QuBits 210, 212 from a sender quantum computing device 224 to a receiver quantum computing device 226. In one embodiment, the sender quantum computing device 224 may correspond to the quantum computing system 109, the receiver quantum computing device 226 may correspond to the quantum computing device 102, and the optical communication channel 228 may correspond to the optical communication channel 133, as all described above with respect to FIG. 1.

In particular embodiments, the optical communication channel 228 may include a quantum tunneling channel 230 suitable for channeling the one or more pairs of entangled QuBits 210, 212 from the sender quantum computing device 224 to the receiver quantum computing device 226. For example, in one embodiment, the one or more pairs of entangled QuBits 210, 212 may tunnel through one or more potential energy barriers as part of the quantum tunneling channel 230 to generate and exchange a quantum cryptographic key (e.g., quantum cryptographic key 128) between the sender quantum computing device 224 and the receiver quantum computing device 226.

In particular embodiments, the quantum tunneling compute component 208 may generate the quantum cryptographic key (e.g., quantum cryptographic key 128) based on a comparison of a first set of measurements of the one or more pairs of entangled QuBits 210, 212 generated by the sender quantum computing device 224 and a second set of measurements of the one or more pairs of entangled QuBits 210, 212 generated by the receiver quantum computing device 226. Upon determining a match between the first set of measurements and the second set of measurements, the quantum tunneling compute component 208 may identify the quantum cryptographic key (e.g., quantum cryptographic key 128) and exchange the quantum cryptographic key (e.g., quantum cryptographic key 128) between the sender quantum computing device 224 and the receiver quantum computing device 226. In this way, the quantum tunneling compute component 208 may ensure secure sensitive data communications between the sender quantum computing device 224 and the receiver quantum computing device 226 and the secure transmission and reception of the encoded sensitive data 214 over the optical communication channel 228.

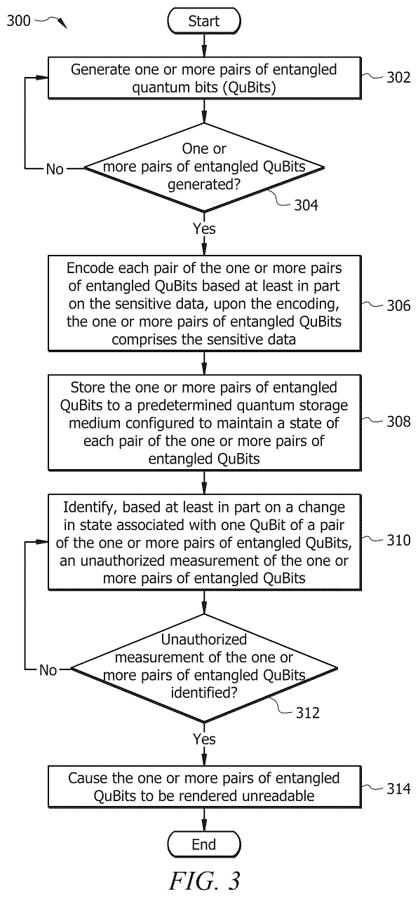

FIG. 3 illustrates a flowchart of an example method 300 for encrypting and securing stored sensitive data based on the quantum echo effect, in accordance with one or more embodiments of the present disclosure. The method 300 may be performed by the combined classical computing and quantum computing system 100 as described above with respect to FIG. 1. For example, in one embodiment, the method 300 may be performed by the quantum computing system 109 alone. In another embodiment, the method 300 may be performed in conjunction by the quantum computing device 102 and the quantum computing system 109.

The method 300 may begin at block 302 with the quantum computing system 109 generating one or more pairs of entangled quantum bits (QuBits) 210, 212. In particular embodiments, the method 300 may continue at decision 304 with the quantum computing system 109 confirming whether the one or more pairs of entangled QuBits 210, 212 have been generated. In particular embodiments, in response to confirming that the one or more pairs of entangled QuBits 210, 212 have not been generated (e.g., at decision 304), the method 300 may return to block 302.

On the other hand, in response to confirming that the one or more pairs of entangled QuBits 210, 212 have been generated (e.g., at decision 304), the method 300 may continue at block 306 with the quantum computing system 109 encoding each pair of the one or more pairs of entangled QuBits 210, 212 based at least in part on the sensitive data (e.g., encoded sensitive data 214), whereupon the encoding, the one or more pairs of entangled QuBits 210, 212 includes the sensitive data (e.g., encoded sensitive data 214). For example, in particular embodiments, the quantum computing system 109 may encode each pair of the one or more pairs of entangled QuBits 210, 212 by utilizing a quantum modulator utilized to alter a polarization or a “spin” of at least one QuBit 210, 212 of each pair of the one or more pairs of entangled QuBits 210, 212.

In particular embodiments, the method 300 may continue at block 308 with the quantum computing system 109 storing the one or more pairs of entangled QuBits 210, 212 to a predetermined quantum storage medium 216 configured to maintain a state of each pair of the one or more pairs of entangled QuBits 210, 212. For example, in particular embodiments, the quantum storage medium 216 may include any quantum storage medium 216 that may be suitable for maintaining the quantum state of each QuBit 210, 210 of each pair of the one or more pairs of entangled QuBits 210, 212 over an extended period of time (e.g., days, months, years, and so forth).

In particular embodiments, the method 300 may continue at block 310 with the quantum computing system 109 identifying, based at least in part on a change in state associated with one QuBit 210, 212 of a pair of the one or more pairs of entangled QuBits 210, 212, an unauthorized measurement (e.g., unauthorized observance 218) of the one or more pairs of entangled QuBits 210, 212. For example, in accordance with the principles of the quantum echo effect, any unauthorized observance 218 (e.g., a measurement) of even one entangled QuBit 210, 212 of each pair of the one or more pairs of entangled QuBits 210, 212 may be identified and detected by the quantum computing system 109.

In particular embodiments, the method 300 may continue at decision 312 with the quantum computing system 109 confirming whether the unauthorized measurement (e.g., unauthorized observance 218) of the one or more pairs of entangled QuBits 210, 212 has been identified. In particular embodiments, in response to confirming that the unauthorized measurement (e.g., unauthorized observance 218) of the one or more pairs of entangled QuBits 210, 212 has not been identified (e.g., at decision 312), the method 300 may return to block 310. On the other hand, in response to confirming that the unauthorized measurement (e.g., unauthorized observance 218) of the one or more pairs of entangled QuBits 210, 212 has been identified (e.g., at decision 312), the method 300 may conclude at block 314 with the quantum computing system 109 causing the one or more pairs of entangled QuBits 210, 212 to be rendered unreadable.

For example, in one embodiment, upon the quantum computing system 109 identifying the unauthorized observance 218 (e.g., a measurement), the quantum computing system 109 may then cause the one or more pairs of entangled QuBits 210, 212 to be rendered unreadable. Specifically, in accordance with the presently disclosed embodiments, the quantum computing system 109 may identify the unauthorized observance 218 (e.g., a measurement) by identifying an “echo” response 222 (e.g., environmental noise) that may reverberate through the quantum storage medium 216 in response to the unauthorized observance 218 (e.g., a measurement).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S. C. § 112(f) as it exists on the date of filing hereof unless the words “means for” or “step for” are explicitly used in the particular claim.

1. A system, comprising:
a quantum memory configured to store sensitive data to be transmitted to a quantum computing device over an optical communication channel; and
one or more quantum processors operably coupled to the quantum memory and configured to:
generate one or more pairs of entangled quantum bits (QuBits);
encode each pair of the one or more pairs of entangled QuBits based at least in part on the sensitive data, wherein, upon the encoding, the one or more pairs of entangled QuBits comprises the sensitive data;
store the one or more pairs of entangled QuBits to a predetermined quantum storage medium configured to maintain a state of each pair of the one or more pairs of entangled QuBits;
identify, based at least in part on a change in state associated with one Qubit of a pair of the one or more pairs of entangled QuBits, an unauthorized measurement of the one or more pairs of entangled QuBits; and
in response to identifying the unauthorized measurement of the one or more pairs of entangled QuBits, cause the one or more pairs of entangled QuBits to be rendered unreadable.

2. The system of claim 1, wherein the quantum storage medium comprises one or more of a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, or a controlled reversible inhomogeneous broadening of a single atomic absorption line (CRIB) storage medium.

3. The system of claim 1, wherein the one or more quantum processors are further configured to:
prior to identifying the unauthorized measurement of the one or more pairs of entangled QuBits:
transmit, over the optical communication channel, the one or more pairs of entangled QuBits to the quantum computing device, wherein the optical communication channel is configured to utilize quantum tunneling to channel the one or more pairs of entangled QuBits to the quantum computing device; and
identify, based at least in part on a comparison of a first set of measurements and a second set of measurements the one or more pairs of entangled QuBits, a quantum cryptographic key, wherein the quantum cryptographic key is configured to be shared between the system and the quantum computing device.

4. The system of claim 1, wherein the one or more quantum processors are further configured to generate the one or more pairs of entangled QuBits by utilizing one or more of a quantum dot (QD), a high-intensity laser, or a quantum particle generator.

5. The system of claim 1, wherein the one or more quantum processors are further configured to encode each pair of the one or more pairs of entangled QuBits by utilizing a quantum modulator configured to alter a polarization or a spin of at least one QuBit of each pair of the one or more pairs of entangled QuBits.

6. The system of claim 1, wherein the one or more pairs of entangled QuBits comprises one or more pairs of entangled photons, one or more pairs of entangled electrons, one or more pairs of entangled neuronal impulses, or one or more pairs of entangled subatomic particles.

7. The system of claim 1, wherein the optical communication channel comprises one or more of an optical fiber link or a free-space optical link.

8. A method, comprising:
generating one or more pairs of entangled quantum bits (QuBits);
encoding each pair of the one or more pairs of entangled QuBits based at least in part on sensitive data to be transmitted to a quantum computing device over an optical communication channel, wherein, upon the encoding, the one or more pairs of entangled QuBits comprises the sensitive data;
storing the one or more pairs of entangled QuBits to a predetermined quantum storage medium configured to maintain a state of each pair of the one or more pairs of entangled QuBits;
identifying, based at least in part on a change in state associated with one Qubit of a pair of the one or more pairs of entangled QuBits, an unauthorized measurement of the one or more pairs of entangled QuBits; and
in response to identifying the unauthorized measurement of the one or more pairs of entangled QuBits, causing the one or more pairs of entangled QuBits to be rendered unreadable.

9. The method of claim 8, wherein the quantum storage medium comprises one or more of a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, or a controlled reversible inhomogeneous broadening of a single atomic absorption line (CRIB) storage medium.

10. The method of claim 8, further comprising:
prior to identifying the unauthorized measurement of the one or more pairs of entangled QuBits:
transmitting, over the optical communication channel, the one or more pairs of entangled QuBits to the quantum computing device, wherein the optical communication channel is configured to utilize quantum tunneling to channel the one or more pairs of entangled QuBits to the quantum computing device; and
identifying, based at least in part on a comparison of a first set of measurements and a second set of measurements the one or more pairs of entangled QuBits, a quantum cryptographic key, wherein the quantum cryptographic key is configured to be shared between a quantum computing system and the quantum computing device.

11. The method of claim 8, wherein generating the one or more pairs of entangled QuBits comprises generating the one or more pairs of entangled QuBits by utilizing one or more of a quantum dot (QD), a high-intensity laser, or a quantum particle generator.

12. The method of claim 8, wherein encoding each pair of the one or more pairs of entangled QuBits further comprises encoding each pair of the one or more pairs of entangled QuBits by utilizing a quantum modulator configured to alter a polarization or a spin of at least one QuBit of each pair of the one or more pairs of entangled QuBits.

13. The method of claim 8, wherein the one or more pairs of entangled QuBits comprises one or more pairs of entangled photons, one or more pairs of entangled electrons, one or more pairs of entangled neuronal impulses, or one or more pairs of entangled subatomic particles.

14. The method of claim 8, wherein the optical communication channel comprises one or more of an optical fiber link or a free-space optical link.

15. A non-transitory computer-readable medium storing instructions that, when executed by one or more quantum processors, cause the one or more quantum processors to:
generate one or more pairs of entangled quantum bits (QuBits);
encode each pair of the one or more pairs of entangled QuBits based at least in part on sensitive data to be transmitted to a quantum computing device over an optical communication channel, wherein, upon the encoding, the one or more pairs of entangled QuBits comprises the sensitive data;
store the one or more pairs of entangled QuBits to a predetermined quantum storage medium configured to maintain a state of each pair of the one or more pairs of entangled QuBits;
identify, based at least in part on a change in state associated with one Qubit of a pair of the one or more pairs of entangled QuBits, an unauthorized measurement of the one or more pairs of entangled QuBits; and
in response to identifying the unauthorized measurement of the one or more pairs of entangled QuBits, cause the one or more pairs of entangled QuBits to be rendered unreadable.

16. The non-transitory computer-readable medium of claim 15, wherein the quantum storage medium comprises one or more of a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, or a controlled reversible inhomogeneous broadening of a single atomic absorption line (CRIB) storage medium.

17. The non-transitory computer-readable medium of claim 15, wherein the instructions further cause the one or more quantum processors to:
prior to identifying the unauthorized measurement of the one or more pairs of entangled QuBits:
transmit, over the optical communication channel, the one or more pairs of entangled QuBits to the quantum computing device, wherein the optical communication channel is configured to utilize quantum tunneling to channel the one or more pairs of entangled QuBits to the quantum computing device; and
identify, based at least in part on a comparison of a first set of measurements and a second set of measurements the one or more pairs of entangled QuBits, a quantum cryptographic key, wherein the quantum cryptographic key is configured to be shared between a quantum computing system and the quantum computing device.

18. The non-transitory computer-readable medium of claim 15, wherein the instructions further cause the one or more quantum processors to generate the one or more pairs of entangled QuBits by utilizing one or more of a quantum dot (QD), a high-intensity laser, or a quantum particle generator.

19. The non-transitory computer-readable medium of claim 15, wherein the instructions further cause the one or more quantum processors to encode each pair of the one or more pairs of entangled QuBits by utilizing a quantum modulator configured to alter a polarization or a spin of at least one QuBit of each pair of the one or more pairs of entangled QuBits.

20. The non-transitory computer-readable medium of claim 15, wherein the one or more pairs of entangled QuBits comprises one or more pairs of entangled photons, one or more pairs of entangled electrons, one or more pairs of entangled neuronal impulses, or one or more pairs of entangled subatomic particles.
